(19) United States
(12) Patent Application Publication
(10) Pub. No.: US 2014/0214628 A1
(43) Pub. Date: Jul. 31, 2014

(54) Gesture-Based Product Wishlist And Shared Social Networking

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,240

(22) Filed: Jan. 31, 2013

(51) Int. Cl. G06Q 30/06; G06F 3/01

(52) U.S. Cl. CPC G06Q 30/0643; G06F 3/017
USPC 705/27.1

(57) ABSTRACT

A portable computerized device can implement a method to collect a preference of a user for a product and share that preference over a social media application. The method includes monitoring an indication of a user of the device to a product of interest, identifying the product of interest by referencing a product information database, communicating the product of interest to the social media application, and displaying the product of interest through the social media application.

### BACKGROUND INFORMATION

1. Field of the Disclosure

This present invention is a computer-implemented method that combines a portable device with in-store product browsing and Internet social media. In particular, examples of the present invention are related to Internet “blogging”, wishlists, sharing with Internet social networks and gift lists.

2. Background

Portable computerized devices permit a user to collect and process data from surroundings. A portable computerized device can include a camera device configured to capture an image or a series of images which can collectively be defined as a video feed. Programming upon or accessible by the device can process the image or images to identify useful information. The device can include wireless communication to acquire or send information to a remote server device. A device can additionally or alternatively include a microphone to record audio.

Augmented reality includes software applications that superimpose computer-generated images upon a view of the real world. In one embodiment, augmented reality can be operated upon a portable computerized device embodied as a pair of eyeglasses configured to project graphical images upon the transparent or nearly transparent lens or lenses of the eyeglasses, such that the viewer sees the graphical images in the context of actual objects visible through the lenses. In another embodiment, augmented reality can be operated upon a smart-phone, a tablet computer, or other similar portable device.

Augmented reality can provide computer generated graphical images superimposed upon a visual scene of an area proximate to the viewer. In combination with image recognition and programming permitting identification of features in a view, graphical images can be projected to identify an object of interest in the view. Graphical images can be configured to interact in an amusing way or otherwise entertain the viewer. Graphical images can provide instruction or augment the view with supplemental information. By superimposing images upon a view of objects in the real world, the experience of the viewer can be enhanced with information, entertainment, or other graphical content.

A portable computerized device can include software applications that capture product barcodes, QR codes, images of packaging details, or other identifying marks, and by matching these marks to those in a centralized database, identify the product so that it can then be later used.

Social media websites are well known in the art and permit a person to share thoughts, hopes, and future intentions with friends and family. Social media applications can be operated upon personal computers or portable computerized devices such a smart-phone, a tablet computer, or other similar portable device.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating an exemplary portable computerized device in communication with an exemplary store product index server, according to some embodiments of the disclosure;

FIG. 2 illustrates an exemplary view of a shelf of products in a retail store including an product of interest being shown on a shelf and a prompt for the viewer to record a comment on the product, according to some embodiments of the present disclosure;

FIG. 3 illustrates an exemplary view through a head-mounted display device of a product and graphics projected upon the device illustrating messages that have been recorded about the product, according to some embodiments of the disclosure;

FIG. 4 illustrates an exemplary computer display showing a wishlist to a shopper and various options for the shopper regarding the wishlist, according to some embodiments of the disclosure;

FIG. 5 is a schematic illustrating an exemplary store product index server, according to some embodiments of the disclosure;

FIGS. 6A and 6B schematically illustrate exemplary portable computerized devices utilizing methods disclosed herein, according to some embodiments of the disclosure;

FIG. 6A is a schematic illustrating an exemplary portable computerized detailed as a head-mounted display configured to record an audio regarding a wishlist;

FIG. 6B is a schematic illustrating an exemplary portable computerized device embodied as a smart-phone;

FIG. 7 is a schematic illustrating an exemplary portable computerized device configured to implement methods disclosed herein, according to some embodiments of the disclosure;

FIGS. 8A-8C illustrate exemplary hand gestures and other information that can be used to select and capture a product for a wishlist, according to some embodiments of the disclosure;

FIG. 8A illustrates a finger pointing at an exemplary product and an accompanying verbal cue to identify the product for a wishlist;

FIG. 8B illustrates an index finger and a thumb indexing an exemplary barcode label to identify a product for a wishlist;

FIG. 8C illustrates a finger pointing to an exemplary advertising flyer and making an exemplary circular gesture to identify a product upon the flyer;

FIG. 9 is a flowchart illustrating an exemplary process to create a wishlist with a portable computerized device, according to some embodiments of the disclosure; and

FIG. 10 is a flowchart illustrating an exemplary process to purchase objects from a wishlist created upon a portable computerized device, according to some embodiments of the disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

An individual wishing to share a shopping experience, for example, by creating a wishlist and/or recording a message regarding a product, can utilize a portable computerized device such as a head-mounted display (HMD). The individual can browse the aisles of a store, stopping when a store product becomes a product of interest to that person and catches his or her attention. The device can monitor an indication from the individual, which can be individually or a combination of a hand gesture, a voice command, or an eye gaze location. Based upon the indication, the portable computerized device can identify the product corresponding to the indication and take an action, such as add the product to a wishlist or record a message by the individual regarding the product for sharing upon social media.

A wishlist for an individual or a list creator can be stored within a server device for access by the individual or by others permitted access to the list by the individual. Such a wishlist can be a registry, for example, for a wedding or a baby shower. Such a wishlist can be a holiday gift list that the individual is collecting to purchase for a group of other people. The wishlist can be for others to purchase for the individual making the wishlist. The wishlist can include specific products, for example, identified by a specific product code that can be searched for in the store inventory. The wishlist can also include ambiguous products, for example, permitting the individual making the wishlist to capture three different products and record a message saying that he or she would like any one of the three products or an equivalent product.

An audio, video, or text message can be recorded regarding a product. The message can published by the individual recording the message for friends or family members to access in order to enable one of the friends or family members to purchase the correct product for the individual and share in the individual's enthusiasm for the product. A grandparent that has no concept of a particular toy can watch a video message by a grandchild regarding a particular product and be prepared to discuss the product when it is given as a gift. Additionally, sharing of the individual's shopping experience can encourage others to purchase the same product in order to share the experience with the individual. In order to record a video message, a camera of the portable device is aimed at a product in the store and the device prompts the individual to make the recording.

A computerized store database can include records for all of the stores products, including pictures, barcodes, descriptions, cost, weight, location, and inventory. The database can also include the messages that various shoppers made for a particular product. According to one embodiment, a generic list of messages for a product, for example, with the identification information of the individuals making the recordings removed, can be made available to shoppers in order to provide the shoppers with information regarding what products are currently popular or in high demand.

Identifying a product corresponding to a gesture or other indication can be accomplished according to a number of exemplary embodiments. For example, barcodes and visual information from the packaging of the product can be used to identify a particular product. Additionally, a current location of the device within the store can be used to identify a product proximate to the device. A number of methods are known to geographically locate a device. Cell tower signals can be use to triangulate a position of the device. In another embodiment, global positioning system (GPS) coordinates can be used to acquire an approximate location of the device. Methods are known to improve the accuracy of a location based upon (GPS) coordinates. For example, a set location in the store can provide an accurate starting location, and location within the store can be tracked based upon changes to the global positioning coordinates. Such an initial location can be set, for example, by providing a QR code at a set location, and as the portable computerized device is keyed to scan the QR code, the initial location can be set. In another embodiment, the augmented reality program can localize its location by recognizing landmarks within the store through pattern recognition software, for example, by recognizing aisle marker signs located on the ends of the aisles or suspended from the ceiling. Based upon such landmarks, motion relative to the landmarks can be tracked by sensors such as an accelerometer, a gyroscope, and/or a compass. In another embodiment, a plurality of localizing signals within and/or outside of the store could be used to determine a location of the device. For example, a radio transmitter within the store and signals from two nearby cell towers could be used to triangulate a position of the device. Additionally or alternatively, accelerometers can also be used to track movement. A number of methods are known to locate and track movement of a device within a store, and the disclosure is not intended to be limited to the particular exemplary methods disclosed herein.

Operation of a HMD or any portable computerized device as disclosed herein is dependent upon a computerized component. Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied as any tangible medium of expression having computer-usable program code embodied in the medium.

In one embodiment, a HMD user looks at a product of interest and by making a gesture, whether by hand, voice, or by other means, a shopping list or wishlist is generated. The user of the HMD or portable computerized device can then tag, in real time, the product of interest and create a brief video and talk about the product of interest. A list created in the store can later be edited, for example, by the individual that created a list or a person put in charge of the list for the individual. For example, a parent reviewing the list for a child can compare prices and age guidelines for a product to the parent's expectations and adjust the list accordingly. Alternatively, a parent shopping for a college-age child can permit the child to adjust the list according to what the child actually wants. The list can be published in a way that includes access to a catalog of products also available at the store, such that products can be moved on and off of the list easily. Favorite shopping lists and wishlists can be saved and reused. Objects can be added to the list during a subsequent shopping trip, for example, or a new list can be created.

The software to capture retail products of interest can be owned and controlled by a particular retail establishment or a third party and operated on the HMD or portable computerized device owned by the customer. Store control of the program provides for accurate locations of products within the store being available to users of the program. The store is in the best position to provide and maintain an accurate list of products and product locations within the store. Installation of the augmented reality program can be achieved by making the necessary software available for download from a website, purchase in known software formats, such as delivery by compact disk or by flash drive, or by any other known methods of software delivery and installation.

Building and maintaining a database for locating products or specific locations within a store can be accomplished through a number of methods. For example, a store can maintain such a location database for assisting store personnel in stocking and auditing the store inventory. In such an event, the already existing database could be adapted for use with the methods disclosed herein.

Products on a list can be used to form a shopping list for a shopper to take to the store. In one embodiment, this shopping list can be used with augmented reality programs to guide the shopper in the store to the right products. By comparing a current location of a portable computerized device of the shopper to an in-store location of a product on the shopping list, navigational instructions and graphics indicating to the particular product can be generated to aid the shopper.

Hardware and software configurations of the systems disclosed herein can take many different embodiments. An augmented reality program can be installed upon a portable computerized device. In another embodiment, a portable computerized device can include an augmented reality program configured permanently to the hardware of the device. In one embodiment, a single store product index server can be utilized remotely to provide product locations in a plurality of stores, with communication of necessary information being transferred over a communications network. In another embodiment, a single remotely operated store product index server can be used to provide product locations for a single store. In one embodiment, a remote server can be used as a store product index server, and a second, local, in-store server can be used to permit local wireless communication between customers and the local server. In another embodiment, a store product index server can be local to a store. Communication between portable computerized devices and a store product index server can be over a cellular network, over a local network operated by the store, or by other communications methods known in the art.

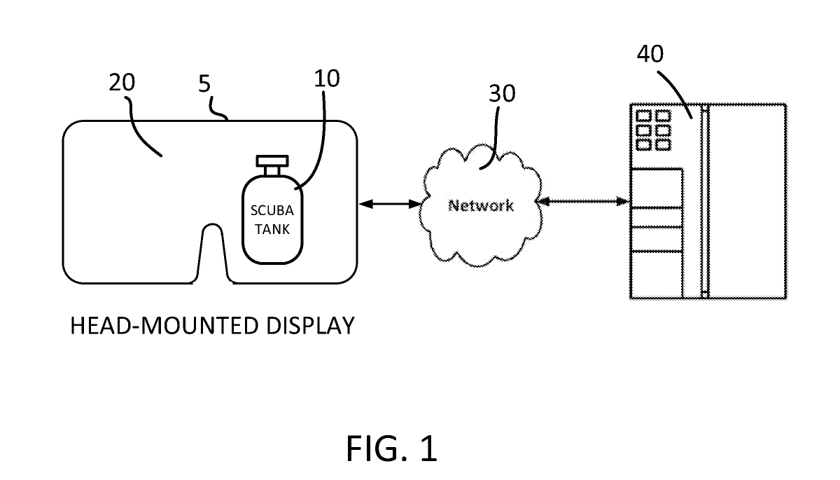

FIG. 1 is a schematic illustrating an exemplary portable computerized device in communication with an exemplary store product index server. HMD device 5 is illustrated, including view 20 through device 5. Included within view 20 is product 10. Device 5 is an exemplary portable computerized device including input devices configured to gather information and a processor configured to make determinations regarding data from the input devices. Store product index server 40 is illustrated including a remote computerized system with modules operating to share information gathered from device 5 with social media applications as disclosed herein. Server 40 and device 5 are in communication through exemplary wireless communications network 30.

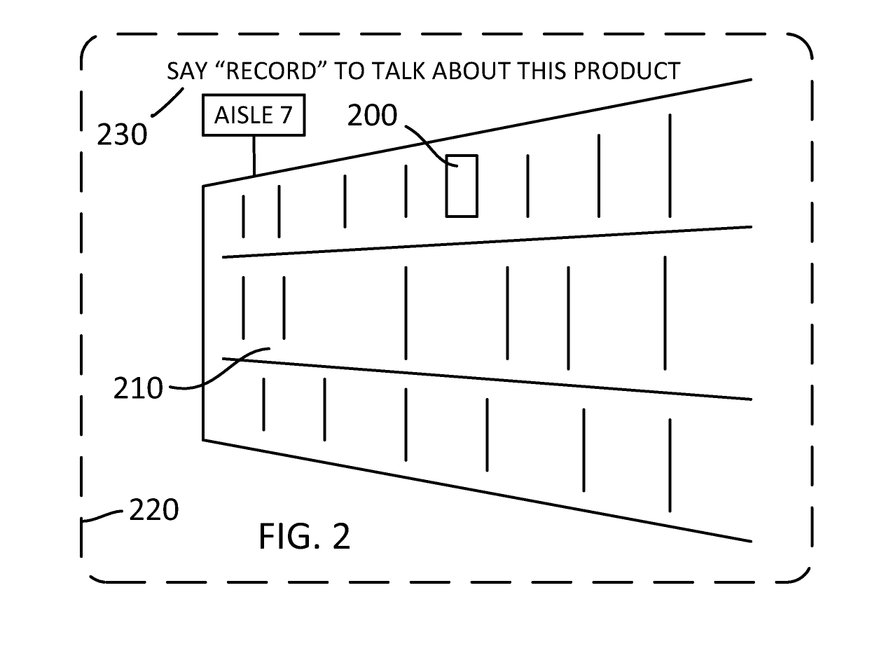

FIG. 2 illustrates an exemplary view of a shelf of products in a retail store including an product of interest being shown on a shelf and a prompt for the viewer to record a comment on the product. View 220 can illustrate objects visible through an HMD device or a video feed projected upon a portable computerized device. Store shelves 210 are visible in the view, as are products upon the shelves. Further view 220 can include graphics projected upon the view of the individual using the device. A particular product can be indicated to or selected according to methods disclosed herein, and an indicating graphic 200 can be projected pointing to or highlighting the product upon the shelves. Additionally, a message 230 can be projected upon view 220 prompting an action from the individual, for example, prompting an audio input to initiate recording a message related to the product. In another embodiment, a beep or a recorded audio message prompting the individual to initiate a recording can be utilized.

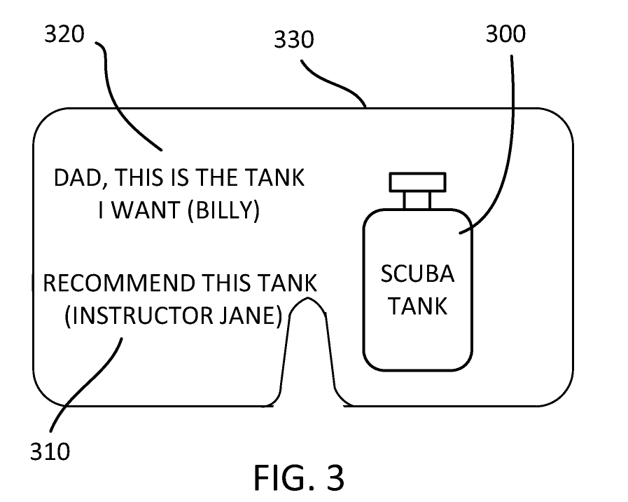

FIG. 3 illustrates an exemplary view through a head-mounted display device of a product and graphics projected upon the device illustrating messages that have been recorded about the product. View 330 includes a product 300 located within a retail store. Through methods disclosed herein, the product can be indicated to be the individual using the device, the product can be identified within the store product index server, and details regarding the device can be displayed upon the device. The device can, for example, access social media applications and determine what friends and family have said about the product. Exemplary messages 310 and 320 are illustrated.

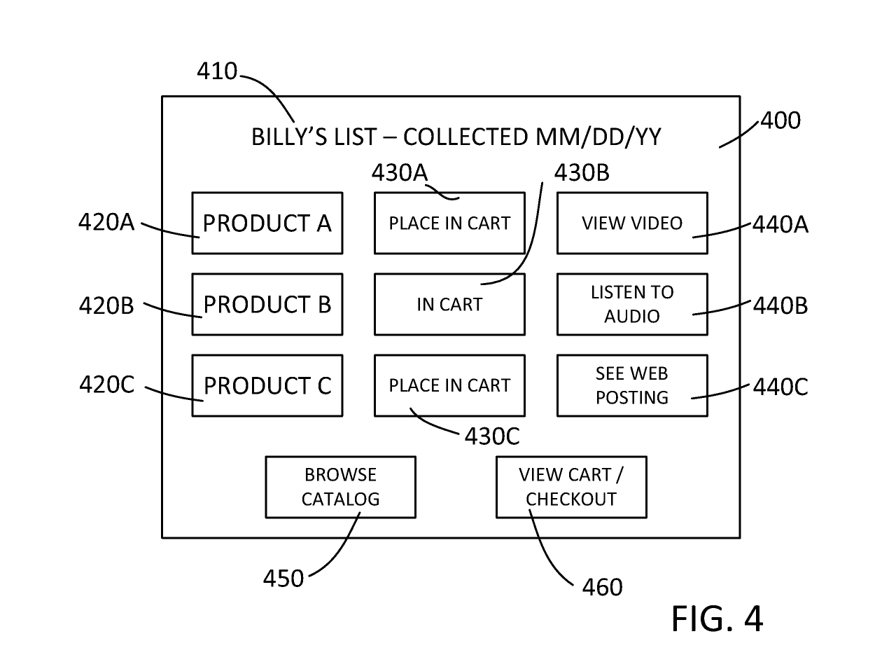

FIG. 4 illustrates an exemplary computer display showing a wishlist to a shopper and various options for the shopper regarding the wishlist. Display 400 includes a descriptive banner 410 identifying the displayed list. Display 400 further includes a list of products upon the list including products 420A, 420B, and 420C. Display 400 further includes shopping prompts 430A, 430B, and 430C permitting action by a view of the display to transfer products from the wishlist to a virtual shopping cart. Display 400 further includes prompts to permit the viewer to review messages recorded by the creator of the wishlist regarding each of products 420A, 420B, and 420C, including corresponding messages including a prompt 440A to view a video message, prompt 440B to listen to an audio message, and prompt 440C to review text or other entries that the creator made as a web posting. Additionally, an input 450 is provided permitting the viewer to switch the display to browse a catalog of inventory available through the store, for example, to find a substitute for an product on the wishlist. Additionally, an input 460 is provided permitting the viewer to view the virtual shopping cart and/or to initiate a check out process to complete a current order. A number of additional or alternative display options for display 400 are envisioned, and the disclosure is not intended to be limited to the particular examples provided herein.

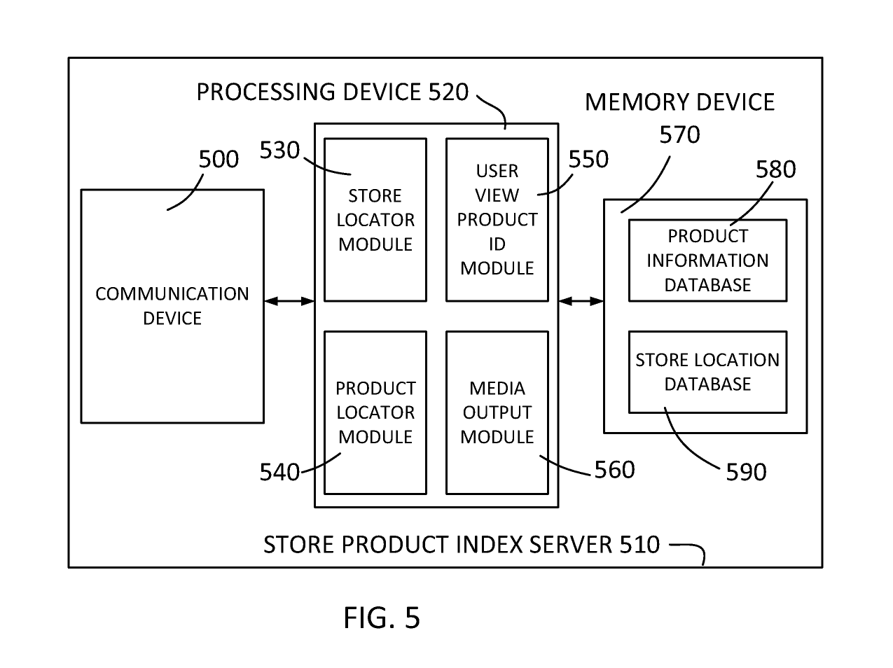

FIG. 5 is a schematic illustrating an exemplary store product index server. In the illustrated embodiment, the store product index server 510 may include a processing device 520, a communication device 500, and memory device 570.

The processing device 520 can include memory, e.g., read only memory (ROM) and random access memory (RAM), storing processor-executable instructions and one or more processors that execute the processor-executable instructions. In embodiments where the processing device 520 includes two or more processors, the processors can operate in a parallel or distributed manner. In the illustrative embodiment, the processing device 520 executes one or more of a store locator module 530, a product locator module 540, a user view product identification module 550, and a media output module 560.

The communication device 500 is a device that allows the store product index server 510 to communicate with another device, e.g., a portable computerized device through a wireless communication network connection. The communication device 500 can include one or more wireless transceivers for performing wireless communication and/or one or more communication ports for performing wired communication.

The memory device 570 is a device that stores data generated or received by the store product index server 510. The memory device 570 can include, but is not limited to a hard disc drive, an optical disc drive, and/or a flash memory drive. Further, the memory device 570 may be distributed and located at multiple locations. The memory device 570 is accessible to the processing device 520. In some embodiments, the memory device 570 includes a store location database 590 and a product information database 580.

In some embodiments, the store location database 590 can store the store locations of one or more stores operated or associated with a retailer. The store location database 590 may be queried using a specific location, e.g., GPS coordinates, or a general location, e.g., postal zip code or city/state, and can return one or more stores that are proximate to the specific or general location. The store location database 590 may further be configured to store maps corresponding to each store location. The store location database 590 may be queried with a store location and can return the store map corresponding to the store location.

In some embodiments, the product information database 580 stores information about a product including a location of a product within a store. The product information database can be used to query a particular product available at location, or a class of items available near a certain location. For example, a location can provide that the device is located in front of a display of soup without being able to specify a particular soup selected based solely upon the location of the device.

The product information database 580 may further store a type of each product sold by the retailer, e.g., groceries, home decor, and personal goods, and/or a section of the product, e.g., dairy or men's clothing. Furthermore, the types and/or sections can be stored relative to each store location. In this way, the product information database 580 can be queried with a store location and a product and can return a type of the product and/or a section of the product at the store location.

The product information database 580 may further store other information about a particular product, including price, weight, availability, and similarity of the product to other available products.

As discussed, the processing device 520 may execute the store locator module 530. The store locator module 530 receives a location from a portable computerized device and determines one or more store locations corresponding to the received location. In some embodiments, the store locator module 530 queries the store location database 590 with the received location and receives one or more store locations that correspond to the received location. For example, the store location database 590 may return any store locations that are within a predetermined distance, e.g., 10 miles, from the received location. When more than one store location is received, the store locator module 530 may automatically select the store location nearest to the received location or may provide the store locations to the portable computerized device, thereby allowing the portable computerized device or the user to select the store location.

The product locator module 540 can monitor an product that has been indicated to and reference the product database 580 to determine based upon a location in the store a product or a list of products that the indicated to product could be. This location data can be combined within user view product ID module 550 with other data, such as a captured image of the packaging of the product, to positively identify the product desired by an individual using the portable computerized device. Media output module can manage information related to the identified product, such as recorded messages, and can manage a pending wishlist for output to social media applications. Product locator module 540 can provide the object location to media output module 560 such that location and product identification information can be electronically linked to the product of interest and then uploaded to a social media application.

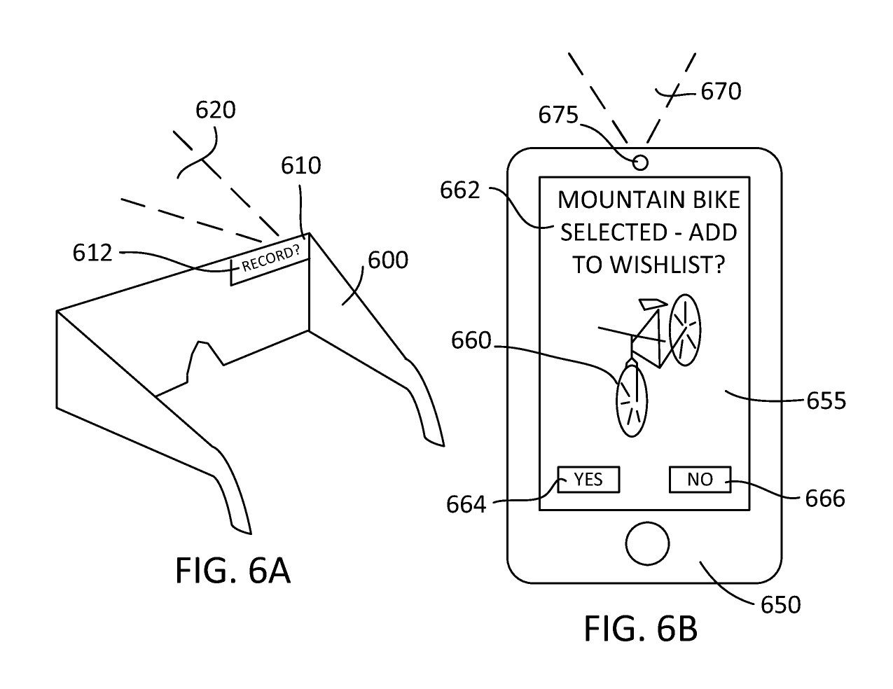

FIGS. 6A and 6B schematically illustrate exemplary portable computerized devices utilizing methods disclosed herein. FIG. 6A is a schematic illustrating an exemplary portable computerized detailed as a head-mounted display configured to record an audio regarding a wishlist. HMD device 600 includes a display 610 located to a corner of a view through the device. Display 610 includes message 612 prompting the viewer to initiate a recording regarding a product currently being viewed. Device 600 additionally includes a camera device capturing view 620 in front of the device. FIG. 6B is a schematic illustrating an exemplary portable computerized device embodied as a smart-phone. Device 650 includes display 655 including a view 670 captured by a camera located on an opposite side of device 650 from display 655. An optional additional camera device 675 is displayed that can be used to determine a gaze location of the user of the device. A product 660 is included upon display 655. A message 662 prompting the user to confirm whether product 660 should be added to a wishlist is additionally displayed, including inputs 664 and 666 permitting the user to confirm or reject, respectively, the viewed product for the wishlist.

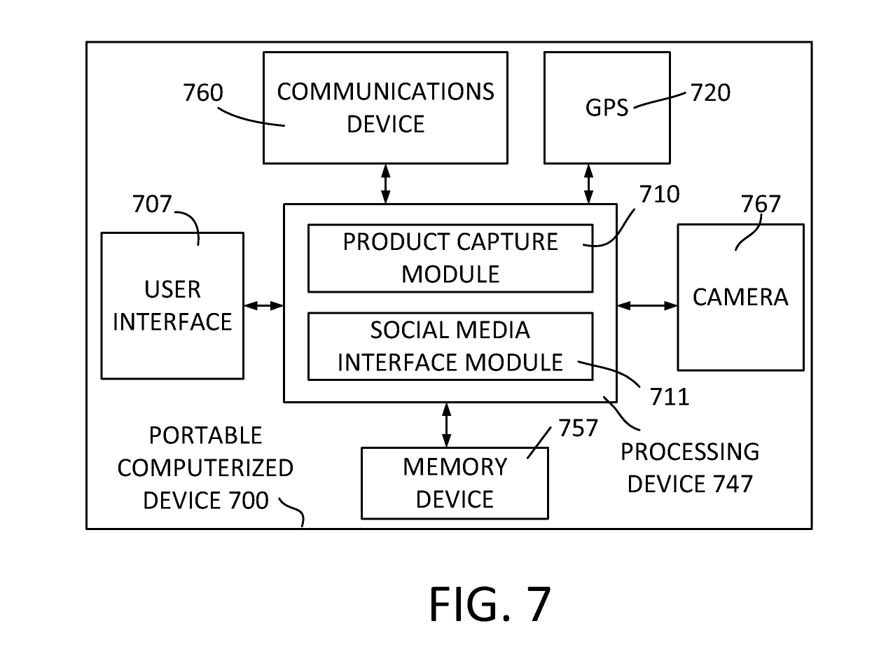

FIG. 7 is a schematic illustrating an exemplary portable computerized device configured to implement methods disclosed herein. Device 700 includes a processing device 747, a user interface 707, a communication device 760, a GPS device 720, a camera 767, and a memory device 757.

The processing device 747 can include memory, e.g., read only memory (ROM) and random access memory (RAM), storing processor-executable memory (ROM) and random access memory (RAM), storing processor-executable instructions and one or more processors that execute the processor-executable instructions. In embodiments where the processing device 747 includes two or more processors, the processors can operate in a parallel or distributed manner. In the illustrative embodiment, the processing device 747 can execute the operating system of the portable computerized device. In the illustrative embodiment, the processing device 747 also executes an object/task list module 710 and a social media interface module 711, which are described in greater detail below.

The user interface 707 is a device that allows a user to interact with the portable computerized device. While one user interface 707 is shown, the term “user interface” can include, but is not limited to, a touch screen, a physical keyboard, a mouse, a microphone, and/or a speaker. The communication device 760 is a device that allows the portable computerized device to communicate with another device, e.g., a store product index server. The communication device 760 can include one or more wireless transceivers for performing wireless communication and/or one or more communication ports for performing wired communication. The memory device 757 is a device that stores data generated or received by the portable computerized device. The memory device 757 can include, but is not limited to, a hard disc drive, an optical disc drive, and/or a flash memory drive.

The GPS 720 determines a location of the portable computerized device by communicating with a plurality of GPS satellites. The GPS 720 can perform known triangulation techniques to determine the GPS coordinates of the portable computerized device. It should be appreciated that while a GPS 720 is shown, any other suitable component for determining the location of the portable computerized device can be implemented.

The camera 767 is a digital camera that captures a digital photograph. The camera 767 receives an instruction to capture an image and captures an image of a view proximate to the camera. The digital photograph can be a bitmap file. The bitmap file can be a bitmap, a JPEG, a GIF, or any other suitably formatted file. The camera 767 can receive the instruction to capture the image from the processing device 747 and can output the digital photograph to the processing device 747.

Product capture module 710 monitors images captured by camera 767 and/or other inputs that can be used to indicate to a product. Product capture module 710, upon monitoring an indication to a product, uses image recognition, barcode recognition, or other methods to index the product. Information gathered by product capture module can be communicated to the product store index server to particularly identify the product for sharing according to the methods disclosed herein.

Social media interface module 711 interfaces with particular social media applications to present options to the user for sharing information about an indicated product. Social media interface module 711 further collects information through the user interface 707 regarding the product, such as a recorded message or an indication expressing that the product is a favorite of the user, and communicates the collected information to the social media application. Different embodiments of the disclosure can include social media interface module 711 and a media output module of a store product index server implementing different portions of the tasks required to share the product information as disclosed herein.

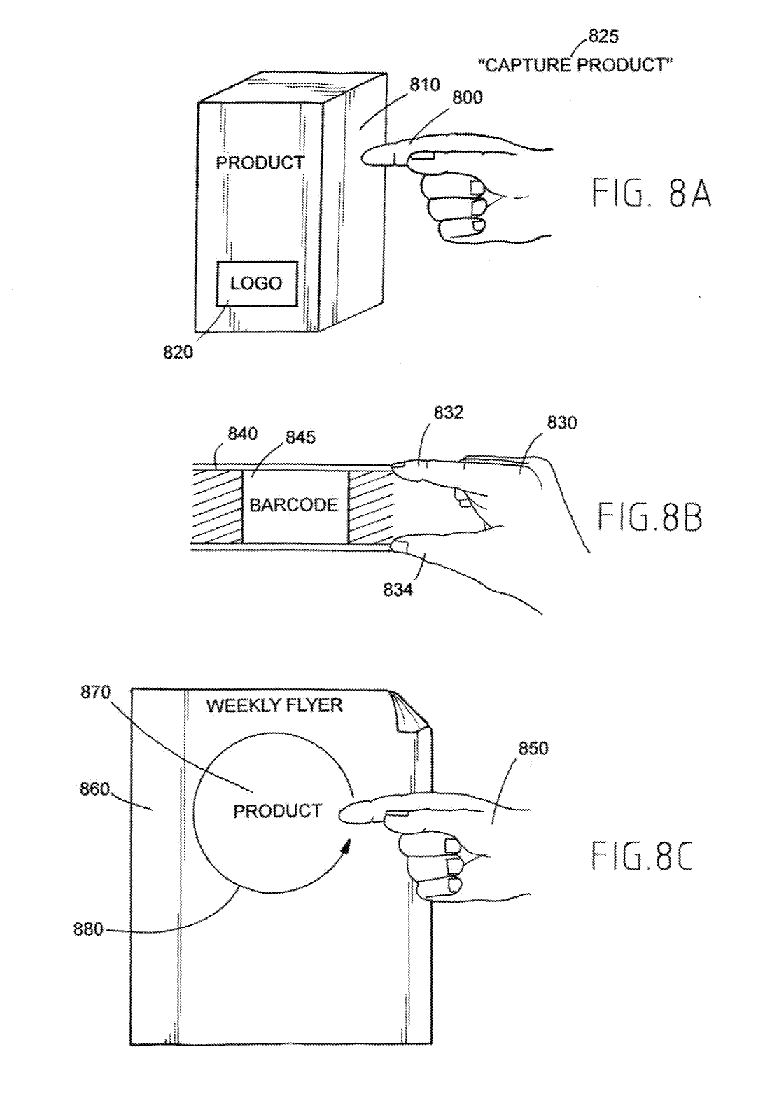

A hand gesture for identifying a product within a retail store can include a number of embodiments. FIGS. 8A-8C illustrate exemplary hand gestures and other information that can be used to select and capture a product for a wishlist. FIG. 8A illustrates a finger pointing at an exemplary product and an accompanying verbal cue to identify the product for a wishlist. Hand 800 is illustrated pointing to product 810. Image recognition programming within a portable computerized device can recognize an extended index finger as an indication to a product. Further, a voice prompt initiating the device to look for the extended finger can optionally be used. A verbal prompt 825 by the user is illustrated, with the user instructing the device to look for the extended finger. Further, packaging 820 on product 810 can be identified to aid in identifying the product indicated to.

FIG. 8B illustrates an index finger and a thumb indexing an exemplary barcode label to identify a product for a wishlist. Hand 830 is illustrated including index finger 832 and thumb 834 in a pinching gesture. The finger and thumb are illustrated indicating to a barcode label 845 located upon shelf 840. The gesture of pinching the fingers toward the barcode label 845 can be used as a gesture to indicate to the product corresponding to the barcode label.

FIG. 8C illustrates a finger pointing to an exemplary advertising flyer and making an exemplary circular gesture to identify a product upon the flyer. Advertising flyer 860 is illustrated including a graphic advertising product 870. Hand 850 is illustrated with an extended index finger. By rotating the index finger in a circular motion 880 around product 870, programming within a portable computerized device can identify the product being indicated to. Identification of the product can be accomplished by visual details of the illustrated product, for example, by logos or QR codes provided upon the flyer, or the flyer can be registered with the programming, such that if the user indicates to a top half of the second page of the weekly flyer, the programming can determine the desired product according to the registered flyer. A number if hand gestures and other methods to indicate to a product are envisioned, and the disclosure is not intended to be limited to the particular examples provided herein.

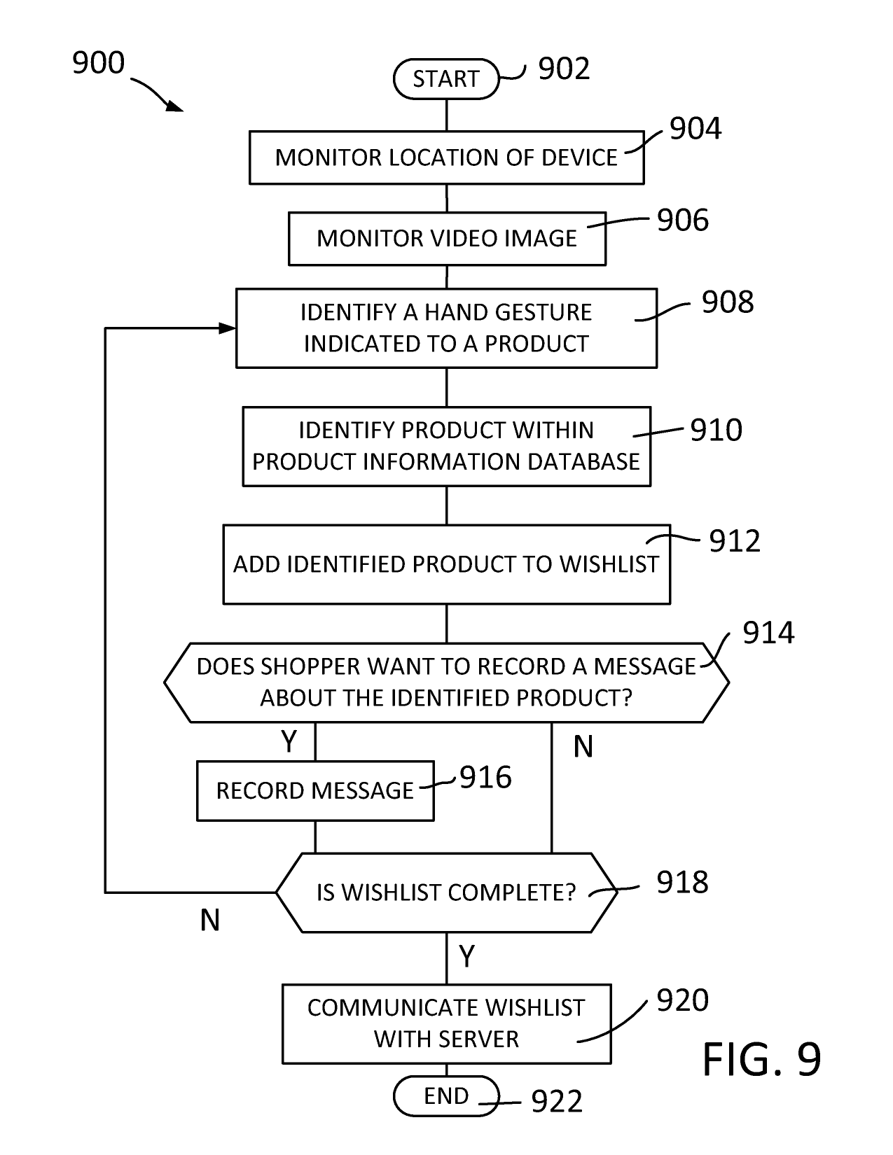

FIG. 9 is a flowchart illustrating an exemplary process to create a wishlist with a portable computerized device. Process 900 operates within a portable computerized device and begins at step 902. At step 904, the process monitors a location of the device within a retail store according to methods disclosed herein. At step 906, a video image captured by a camera of the device is monitored. At step 908, the video image is analyzed, and a hand gesture to a product is identified. At step 910, a product information database is referenced, and the product indicated to is identified within the database. At step 912, the identified product is added to a wishlist. At step 914, the user of the device is prompted to record a message about the identified product. If the user declines to record a message, process 900 advances to step 918. If the user opts to record a message, process 900 advances to step 916 whereat a message related to the identified product is recorded. At step 918, a determination is made whether the wishlist is complete. If the wishlist is not complete, the process returns to step 908. If the wishlist is complete, the process advances to step 920 whereat the wishlist is communicated to a server. At step 922, the process ends. The process illustrated is a non-limiting example. A number of exemplary processes are envisioned, including a process not monitoring the location the device, a process prompting the user to record one of several different messages about the product, or a process wherein the wishlist is updated in real-time to the server, are envisioned. The disclosure is not intended to be limited to the exemplary process provided.

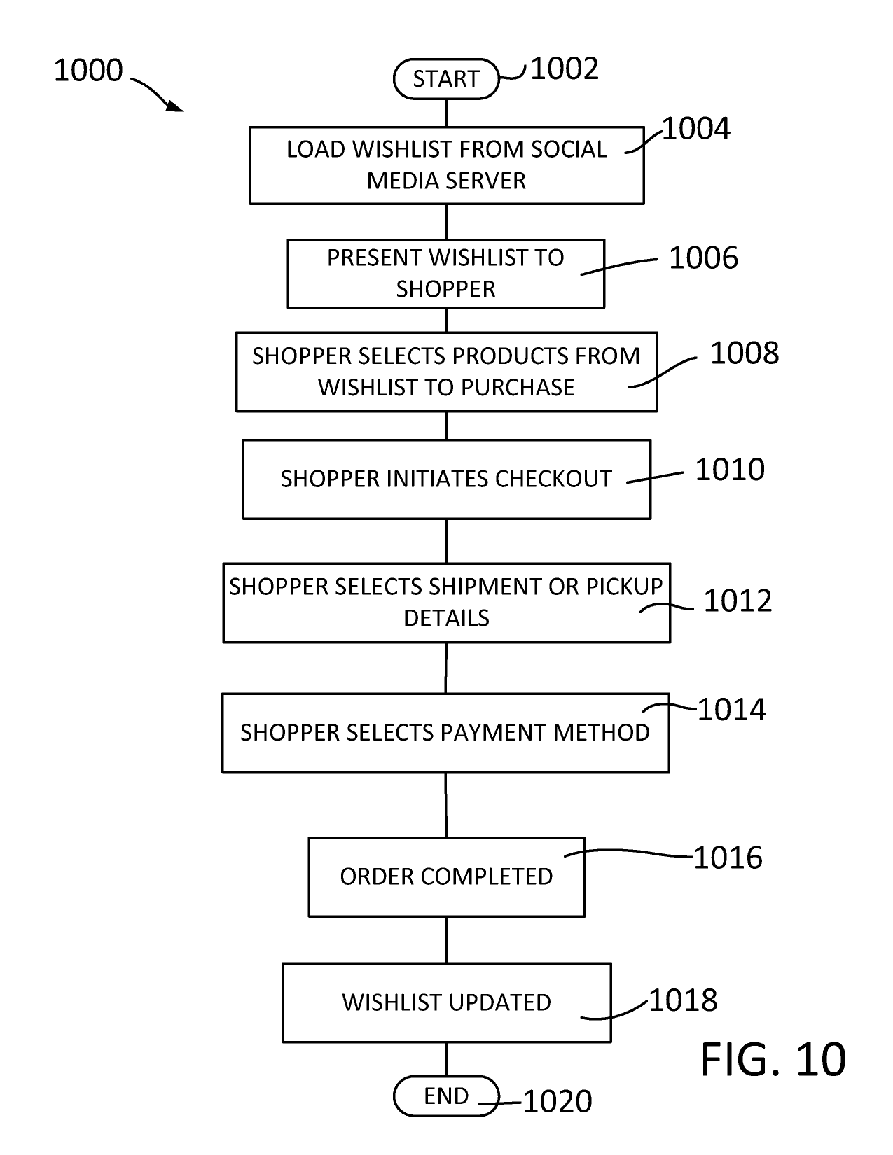

FIG. 10 is a flowchart illustrating an exemplary process to purchase objects from a wishlist created upon a portable computerized device. Process 1000 operates within a computerized device and begins at step 1002. At step 1004, a wishlist is loaded from a social media server or application. At step 1006, the wishlist is presented to the shopper, for example, by displaying the list upon a display. At step 1008, the shopper selects products from the wishlist to purchase. At step 1010, the shopper initiates a checkout procedure. At step 1012, the shopper selects shipment or in-store pickup details for the order. At step 1014, the shopper selects a payment method. At step 1016, the order is formally placed and completed. At step 1018, the wishlist is updated, removing the objects that were purchased in the order so that subsequent orders from the wishlist do not include duplicate products. At step 1020 the process ends. A number of exemplary embodiments for shopping from a wish list are envisioned, including methods aiding an in-store shopper to find the products within the store, and the disclosure is not intended to be limited to the particular examples provided herein.

The methods disclosed herein can be used for products from a single store location. In another embodiment, the methods disclosed herein can be used to find products in a single store, but provide for fulfillment of the order from or within any of multiple locations of a retail chain. In another embodiment, orders can be fulfilled from a warehouse location for the retail chain. In another embodiment, products generated on the wishlist can be entered from any of a plurality of locations, advertising mediums, search engines, or other media, and the wishlist can be used to fulfill the products of the wishlist from a single retail chain. In another embodiment, products can be generated on the wishlist from a visit or multiple visits to a retail chain, and the orders can be fulfilled through a third party or multiple third party retailers, for example, permitting the user to price shop for the various products on the list or for a lowest total list price, for example, including shipping charges. In another embodiment, both the wishlist generation and fulfillment can each be accomplished by a wide variety of sources and retails available in coordination with the social media application running the wishlist.

A product can be accidentally indicated to, incorrectly indicated to, or the user can change his or her mind about the product. Further, the user may wish to edit the list. The portable computerized device can provide for a delete item function, a review list function, an undo function, and other functions known in the art for managing a dynamic shopping list or wishlist.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer-implemented method comprising:
in a portable computerized device:
monitoring an indication of a user of the device to a product of interest;
identifying the product of interest by referencing a product information database; and
communicating the product of interest to a social media application; and
displaying the product of interest through the social media application.

2. The computer-implemented method of claim 1, further comprising, in the portable computerized device:
compiling a list of products of interest; and
communicating the list to the social media application.

3. The computer-implemented method of claim 2, further comprising:
in a computerized device, providing the list of products of interest for purchase.

4. The computer-implemented method of claim 3, wherein providing the list for purchase comprises providing the list for purchase to the user of the device.

5. The computer-implemented method of claim 3, wherein the user of the device comprises a first person; and
wherein providing the list for purchase comprises providing the list for purchase to a second person.

6. The computer-implemented method of claim 1, further comprising:
in the portable computerized device, receiving a comment of the user of the device regarding the product of interest; and
displaying the comment through the social media application.

7. The computer-implemented method of claim 6, further comprising:
providing upon a display a first graphic presenting the product of interest for purchase; and
providing upon the display proximately to the first graphic a second graphic presenting the comment of the user.

8. The computer-implemented method of claim 6, wherein receiving the comment comprises recording an audio comment.

9. The computer-implemented method of claim 6, wherein receiving the comment comprises recording a video comment.

10. The computer-implemented method of claim 9, wherein recording a video comment comprises recording data from a camera upon a head-mounted display device configured to capture a view in front of the user.

11. The computer-implemented method of claim 6, wherein receiving the comment comprises receiving a textual comment.

12. The computer-implemented method of claim 1, wherein monitoring an indication of the user comprises:
monitoring data from a camera of the device;
identifying a hand gesture indicating to the product of interest based upon the monitored data; and
determining the indication of the user based upon the identified hand gesture.

13. The computer-implemented method of claim 12, wherein identifying the hand gesture comprises identifying a finger of the user pointed at the product of interest.

14. The computer-implemented method of claim 12, wherein identifying the hand gesture comprises identifying a pinched index finger and thumb of the user indicating to a barcode for the product of interest.

15. The computer-implemented method of claim 11, wherein identifying the hand gesture comprises identifying a finger of the user making a circling gesture around a representation of the product of interest.

16. The computer-implemented method of claim 11, further comprising monitoring a second indication to the product of interest, the second indication selected from a verbal cue of the user, an eye gaze of the user, and an input to a human input device; and
wherein determining the indication of the user is further based upon the monitored second indication.

17. A server comprising:
a user view product identification module that
receives data from a portable computerized device operated by a user in a retail store, the data including a monitored hand gesture by the user to a product of interest; and
identifies a particular product corresponding to the product of interest; and
a media output module that shares the particular product with a social media application, the social media application indicating a preference of the user toward the particular product.

18. The server of claim 17, wherein the media output module performs an operation selected from the following:
the media output module compiles a wishlist for the user comprising the particular product and shares the wishlist with the social media application; and
the media output module communicates to the social media application a comment of the user regarding the particular product.

19. A software application for sharing over a social media application a preference regarding a product within a retail store, the software application operating upon a head-mounted display device, comprising:
receiving, at the head-mounted display device, a video feed of a user of the device making a hand gesture toward the product;
identifying, at the head-mounted display device, that the product is a product of interest based upon the video feed;
indicating, at the head-mounted display device, to the user that the product of interest has been identified, and
communicating, at the head-mounted display device, the product of interest to the social media application.
